(19) United States
(12) Patent Application Publication
(10) Pub. No.: US 2019/0002052 A1
(43) Pub. Date: Jan. 3, 2019

(54) Light Projected Visual Space and Safety System For Bicycles

(71) Applicant: Lumen Labs (HK) Limited, Hong Kong (HK)

(72) Inventors: Haoren Chen, Hong Kong (HK); Eu-wen Ding, Hong Kong (HK); Yuk Yiu Tsang, Hong Kong (HK)

(21) Appl. No.: 16/026,070

(22) Filed: Jul. 3, 2018

Related U.S. Application Data
(60) Provisional application No. 62/528,161, filed on Jul. 3, 2017.

(51) Int. Cl. B62J 6/00; B62J 6/02; B62J 6/04

(52) U.S. Cl. CPC B62J 6/003; B62J 6/005; B62J 6/02; F21W 2103/20; B62J 2006/006; B62J 2006/008; B62J 6/04

(57) ABSTRACT

A light projection system for bicycles that comprises a front light and a rear light that act in tandem to emit light on the sides and beneath the cycle to visually indicate the ‘safety space’ of the cyclist; and to use such lights to indicate cyclists' intention to other commuters. Individually, both the front and rear light can project light as wide as 330°, with sharply defined patterns and objects. The front and rear lights act in concert that allows the projection of light on a surface that is demonstrably more visible, brighter, better defined, which allows the user of such lights signal intentions to other commuters. Moreover, the lights are synchronized so the shape and outline of the projected light field is malleable, thus different shapes can be projected with no loss of luminous flux and/or sharpness.

### CROSS-REFERENCE WITH RELATED APPLICATIONS

This application claims priority to U.S. Patent Application No. 62/528,161 filed Jul. 3, 2017; the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention generally pertains to the field of cautionary lights, light projection and optics, turn signals and indicators, wireless technology, and lighting systems used in transportation, and particularly in self-propelled and small vehicles.

### BACKGROUND

The number of cyclists commuting has been steadily increasing. In the last eight years alone, the number of cyclists has grown from 47.16 million to 66.52 million, and there is a lack of evidence that suggests this trend is stopping. Yet this increase in urban cyclists has seen a corresponding increase in bicycle accidents as well. According to a study published in the Journal of American Medical Association, bicycle injuries have increased 28% from 1998 to 2013, with bicycle-related hospitalizations increasing 121%¹. Research into the causes of bicycle accidents have demonstrably illustrated that accidents are more likely to occur at specific times and areas²—for instances, 29% of all cyclist injuries involved being hit by automobiles, and 75% of bicycle related accidents occurred at, or near, a road junction, with 20% of all bicycle fatalities occurring in the rush hours of 6-9 pm. The biggest reason for such accidents was attributed to the motor-drivers failing to notice the cyclists, accounting for 57% of serious collisions³. ¹http://jamanetwork.com/journals/jama/fullarticle/2432153?resultClick=3²http://www.pedbikeinfo.org/data/factsheet_crash.cfm³http://www.rospa.com/road-safety/advice/pedal-cyclists/facts-figures/#references

### SUMMARY OF THE INVENTION

The present invention endeavors to address these dangerous conditions by providing a light signaling and illumination system that allows cyclists to demonstrate intentions, project safety boundaries via very strong and defined light (referred to hereinafter as ‘Light-field’), increase visibility of cyclists and finally increasing cyclists' visibility.

One aspect of the present invention is a system of interdependent wirelessly connected lighting components and a control module. Crucially, the system derives its utility by having the individual lighting components work interdependently in a synchronized way that projects highly visible virtual safety boundaries around the cyclist, while at the same time allowing the cyclist to indicate on-road intentions that is circumstantial, contextual, and specific to the cyclist moment-by-moment.

Individually, the lighting components perform functions including directional lighting, cautionary lighting, and turn signaling, and optical projection of visual abstractions. The control and data communication between lighting components and a processor can be implemented via a wired or wireless electrical communication infrastructure, wherein the wireless electrical communication protocol may adopt industrial standards such as Wi-Fi and Bluetooth.

Another aspect of the present invention is that multiple on-road/traffic safety functions as well as a litany of cyclist intentions are conveyed through only two user-control buttons. This is achieved by the network of multiple sensors, a remote controller, and lighting components; and a control method that changes output of the lighting components depending on the moment-by-moment context and circumstance of the cyclist.

In accordance to one embodiment, provided is an integrated system comprising two lights, one front and one rear light, electrically connected via a wired or wireless electrical communication infrastructure and are configured to be receive control and data communication signals from a remote controller that is mounted on a bicycle handle bar. The front and rear light is designed to be mounted on a bicycle that is sturdy but also easily dismounted when intended by the cyclist. Specifically, the front light may be mounted on the handle bar, headset or headtube of the bicycle, and the rear light may be mounted on the seat post of the bicycle.

### BRIEF DESCRIPTION OF THE DRAWINGS

Embodiments of the invention are described in more detail hereinafter with reference to the drawings, in which:

FIG. 1 is a schematic diagram of the system in accordance to one embodiment of the present invention;

FIG. 2 provides a detailed schematic of the hardware components making up the front light of FIG. 1;

FIG. 3 provides a detailed schematic of the hardware components making up the rear light of FIG. 1;

FIG. 4 provides a detailed schematic of the hardware components making up the remote controller of FIG. 1;

FIG. 5 is a side view representation of the bicycle with front light and rear light turned on;

FIG. 6 is a bird's eye view representation of the bicycle with front light and rear light turned on;

FIG. 7 is a diagram showing the field and area of emitted light;

FIGS. 8A and 8B show the lighting mode for activation of turn signals; and

FIG. 9 shows the data and communication flow of a turn signaling operation in one embodiment.

### DETAILED DESCRIPTION

In the following description, systems, devices, and apparatuses for light signaling and illumination system used in transportation devices and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Although the present document describes the present invention as applied primarily to bicycles, an ordinarily skilled person in the art will be able adapt its various embodiments to be applied to other types of personal and small-sized transportation devices such as, without limitation, motor-assisted bicycles, tricycles, motor-assisted tricycles, motorcycles, mopeds, trikes, and scooters without undue experimentation.

The ultimate goal of this invention is to improve the safety of cyclists. A cyclist's safety is heavily dependent on being visible to other road users, but even then, motorist miscalculation is a prominent cause in cycling accidents and fatalities. Thus, to improve cyclist safety, the invention herein not only enhances a cyclist visibility, but provides two functions in improving safety: creating a ‘safety space’ using light projection, and allowing cyclist to signal intentions, all the while providing directional light for the cyclist, sustaining cyclist's visibility and visibility of cyclist.

A ‘safety space’ means the minimum space between motorists and the cyclist that should be observed when sharing the same road, as specified in local laws pertaining to cycling. For instance, according to the Queensland Government from the Government of the Commonwealth of Australia, “Motorists must stay wider of bicycle riders by giving a minimum of: 1 meter when passing a bicycle rider in a 60 km/h or less speed zone or 1.5 meters where the speed limit is over 60 km/h.”⁴ ⁴https://www.qld.gov.au/transport/safety/rules/other/cyclists/

As such, the dimension of the safety space light projection observes such laws and safety standards according to a preferred embodiment of the present invention. The boundary of the safety space light projection serves as a visual cue for adjacent and oncoming motorists to maneuver around the cyclist's safety space.

As local relevant laws pertaining to the actual size of the safety space is likely different for different jurisdictions, the safety standards posited by the Queensland Government is used only as a reference described herein for the standard size of the ‘safety space’ in the present invention. An ordinary skilled person in the art will be able to adapt the various embodiments of the present invention to meet the legal requirements and standards of other jurisdictions without undue experimentation.

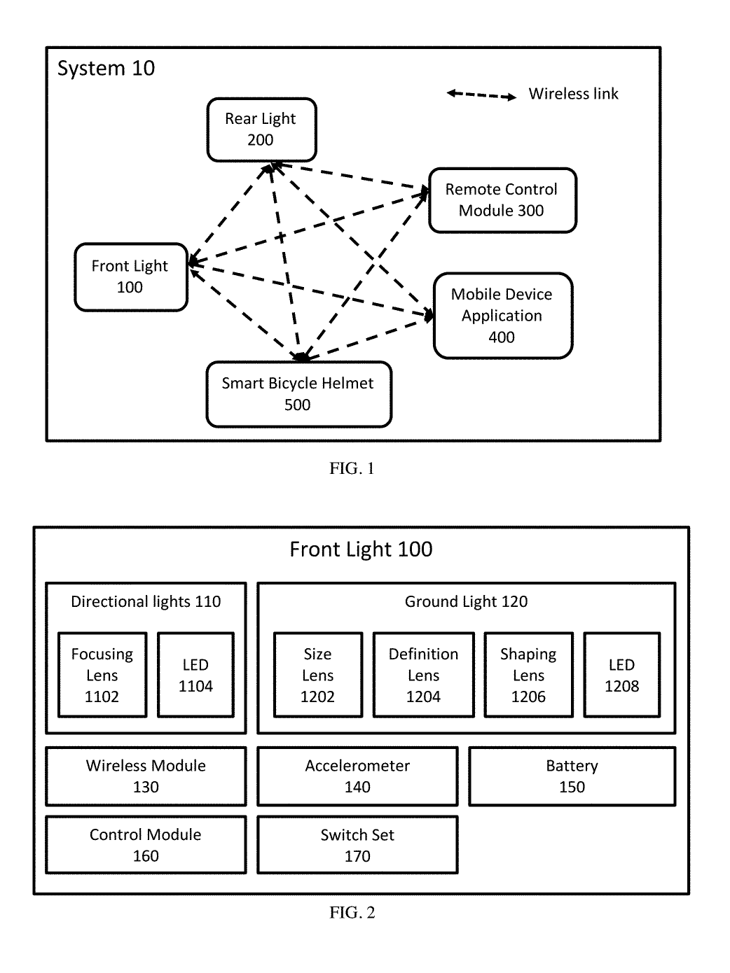

FIG. 1 shows a structural schematic of a system 10 of light signaling and illumination for bicycles. In an embodiment, system 10 comprises a front light 100, a rear light 200 and a remote controller 300. Preferably, the front light 100 is coupled to the handle bar or headtube of the bicycle; the rear light 200 is coupled to the seat post of a bicycle. The remote controller 300 preferably couples to the handle bar of the bicycle for easy access to manage by the cyclist. Additional modules may be provided to expand the functions of the system 10, such as a mobile device application 400 and a bicycle helmet 500, where each of the components or modules communicates wirelessly and may act accordingly to another.

The front light 100, as seen in FIG. 2, comprises two light sources. One of the light sources is for conventional use of increasing the cyclist's visibility by illuminating the frontal space of the bicycle, which is the directional light 110; and the other is for illuminating the ground or projecting the safety space, which is the ground light 120. Directional light 110 includes a focusing lens 1102 that allows the cyclist to adjust the focus and vary the angular width of the emitted light and a corresponding LED 1104 for emitting light. Ground light 120 includes a corresponding LED 1208 and three different lenses for various purposes: (1) a size lens 1202—a focusing lens for varying the angular width of the emitted light and effectively changes the size of the safety space; (2) a definition lens 1204 for changing the definition of the projected safety space; (3) a shaping lens 1206 for changing the shape or visual abstraction of the projected safety space. In one embodiment, the lenses are coupled to electro-mechanical actuators electrically connected to a control module 160, allowing controlled adjustments made electronically.

The front light 100 further includes a wireless module 130, an accelerometer 140, a battery 150, the control module 160 and a switch set 170. A wireless module 130 electrically connected to the control module 160 is provided for wireless communications with other components and modules, and other external devices. An accelerometer 140 is used for measuring acceleration of the bicycle. Acceleration data collected is transmitted via the wireless module 130 to the mobile device application 400. A control module 160 controls the various functions of the front light 100 in accordance to the settings of switch set 170 or the settings in the mobile device application 400 via the wireless module 130. The various functions of the front light 100 includes the on/off, luminance adjustments, and controls of the lens actuators.

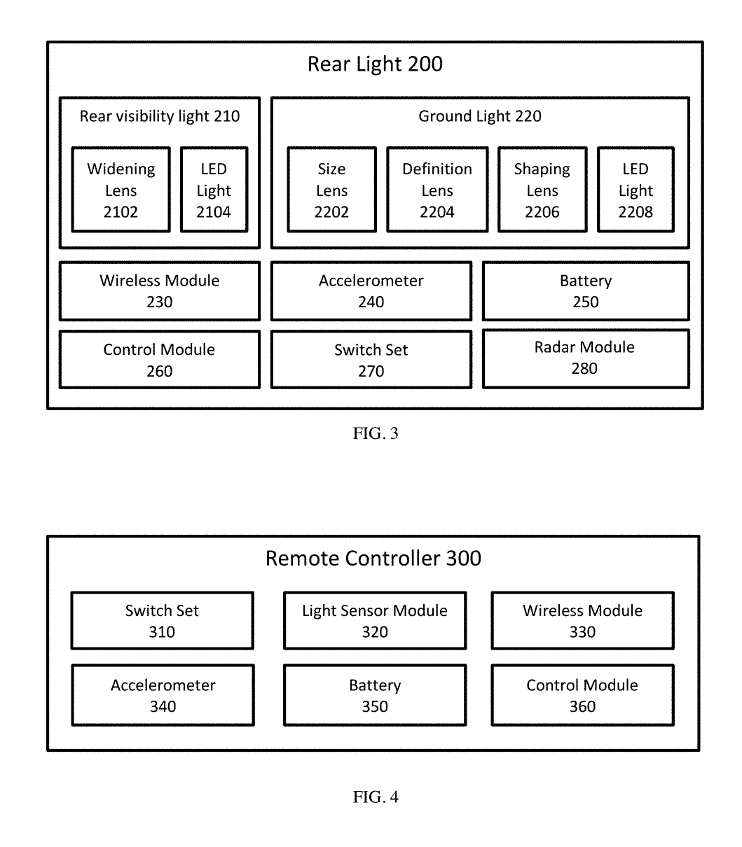

The rear light 200, as seen in FIG. 3, having components and modules substantially the same as the front light 100 and provides similar functions independently. Rear light 200 comprises two light sources, a rear visibility light 210 for providing the visibility of the bicycle to rear and side traffic; a ground light 220 for illuminating the ground and/or projecting safety space. Rear visibility light 210 includes an adjustable focusing lens 2102 that allows users to change the focus and vary the angular width of the emitted light and a corresponding LED 2104 for emitting light. Ground light 220 includes a corresponding LED 2208 and three different lenses for various purposes: (1) a size lens 2202—a focusing lens for varying the angular width of the emitted light and effectively changes the size of the safety space; (2) a definition lens 2204 for changing the definition of the safety space; (3) a shaping lens 2206 for changing the shape or visual abstraction of the projected safety space. In one embodiment, the lenses are coupled to electro-mechanical actuators electrically connected to a control module 260, allowing controlled adjustments made electronically.

The rear light 200 further includes a wireless module 230, an accelerometer 240, a rechargeable battery 250, the control module 260 and a switch set 270. A wireless module 230 is provided for wireless communications with other components and modules, and other external devices. An accelerometer 240 is used for measuring acceleration of the bicycle. Acceleration data collected is transmitted via the wireless module 230 to the mobile device application 400. A control module 260 controls the various functions of the rear light 200 according to the settings of switch set 270 or the settings in the mobile device application 400 via the wireless module 130. The various functions of the front light 100 includes the on/off, luminance adjustments, and controls of the lens actuators.

In one embodiment, a radar module 280 is included for detecting surrounding traffic. The radar data generated is sent to the mobile device application 400 for displaying surrounding traffic condition. The radar data generated is also received by the control module 260 for automatic adjustments of the rear light 200 in response to the surrounding traffic conditions. In one exemplary embodiment, when radar module 280 detected surrounding heavy traffic in that the number of cars is above a threshold number within a time period, and/or cars traveling at high speed above a threshold average speed, e.g. above 60 km/h, the control module 260, in receiving and processing such radar data, causes an expansion of the safe space, e.g. radius from 1 m to 1.5 m, by sending the control signals to adjust the size lenses 1202 and/or 2202.

In one embodiment, one or more of the front light 100, rear light 200 and remote controller 300 may comprise a light sensor and monitors the lighting intensity proximal to cyclists from the light reflection of the ground. Control module 160, 260, or 360 receives the light sensor reading and adjust the luminance according to environment changes, e.g., from day to night or night to day.

Referring to FIG. 4. In accordance to one embodiment of the present invention, the system further comprises a remote controller 300 that functions as a master control over the front light 100 and the rear light 200. Similar to the front light and rear light components, the remote controller 300 includes a wireless module 330, an accelerometer 340, a rechargeable battery 350, a control module 360 and a switch set 310. A wireless module 330 is provided for wireless communications with other components and modules, and other external devices. An accelerometer 340 is used for measuring acceleration of the bicycle. Acceleration data collected is transmitted via the wireless module 330 to the mobile device application 400 and in turn be displayed to the cyclist when the independent accelerometers 140 and 240 are off in order to gather and transfer a continuous signal of acceleration data. A control module 360 is the central processing module for controlling the various functions of the front light 100 and rear light 200 by transmitting control signals to the control modules 150 and 250 according to the settings of switch set 310 and/or the settings in the mobile device application 400 via the wireless module 330. Optionally, a light sensor module 320 is included to measure the luminance around the cyclists and serves two functions: one is to obtain the precise illuminance levels for regulating the radar module 280; another one is to measure the reflected lights from the ground lights 210 and 220 for analyzing the road conditions by the control module 360.

In response to environmental condition changes, settings built in or commands given by the cyclist processed by one or more the control modules 160, 260, and 260 causes one or more changes in the projection size and/or shape, color, intensity, and/or flash frequency of emitted light and light emission modes by sending control signals to each of the adjustable sub-components, such as size lens, shaping lens, and the LEDs. Light emission modes may be solid/constant light emission or strobe/flash light emission. In one embodiment where the system 10 comprises only front light 100 and rear light 200, the corresponding control modules 160 and 260 communicate and synchronize the settings or lighting mode with each other via their respective wireless modules. In another embodiment where the system 10 further comprises a remote controller 300, the control module 360 takes over control of control modules 160 and 260 to communicate and synchronize the settings and/or lighting mode of front light 100 and rear light 200 via the wireless modules, unless remote controller 300 is deactivated, then control modules 160 and 260 take back the control.

Preferably, batteries 150, 250 and 350 are rechargeable batteries.

The front light 100 and rear light 200 of system 10 achieve a 360° light emission that can circumvent physical barriers due to the positioning of front light 100 and rear light 200, as well as the fact that each of them contains two light sources that are angled differently. Both the front light 100 and rear light 200 can individually emit light at an angle of 360°, but when mounted on a bicycle, a slightly smaller angle of illumination is practically achieved due to the bicycle frame being a physical barrier and necessarily a blind-spot. In one aspect, both the directional light 110 and ground light 120 of front light 100 are mounted on the handle bar of the bicycle, and both the rear visibility light 210 and ground light 220 of rear light 200 are mounted on the seat post below the saddle of a bicycle.

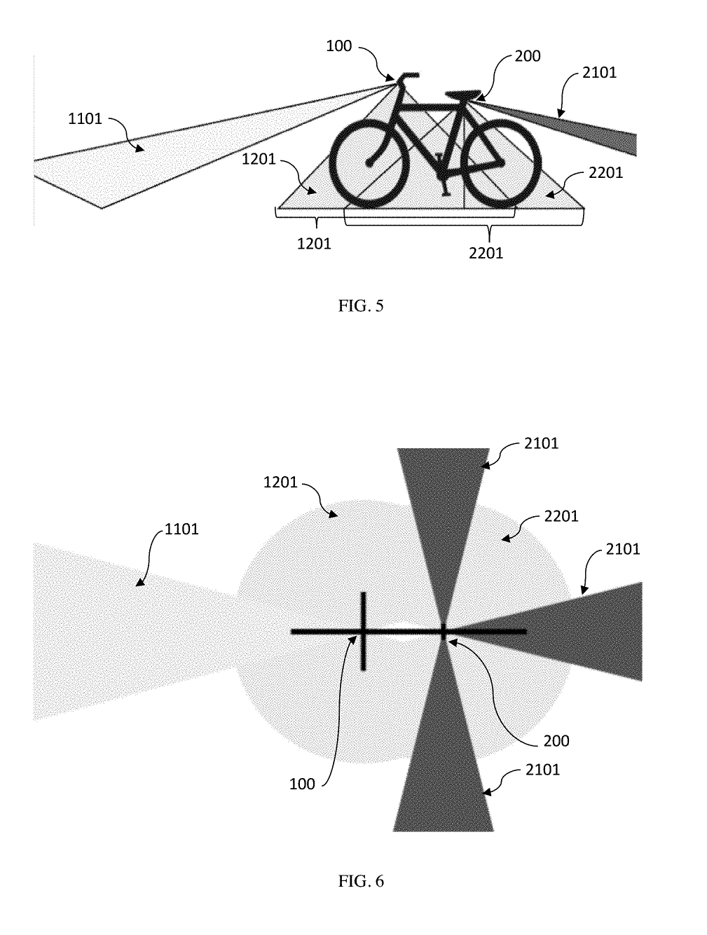

Referring to FIGS. 5 and 6. The ground light 120 of front light 100 inclines above a pre-defined angle from the perpendicular to the ground and emits light and projects a cone shape of first light field or a light zone 1201 on pre-determined positions beneath the top portions of the bicycle proximal to bicycle defining a safety space being conspicuous. The ground light 220 of rear light 200 inclines above a pre-defined angle from the perpendicular to the ground and emits light and projects a cone shape of second light field or a light zone 2201 on pre-determined positions beneath the top portions of the bicycle proximal to bicycle defining a safety space being conspicuous. Light zones 1201 and 2201 are sometimes called light-fields' and they are referred to as ‘safety space’ in present disclosure. When the ground lights 120 and 220 face right angled towards the ground, i.e. the pre-defined angle is 0°, light zones 1201 and 2201 are circular on the projected ground in default setting. Light zones 1201 and 2201 may intersect each other with increased radii 1209 and 2209 of the light projections.

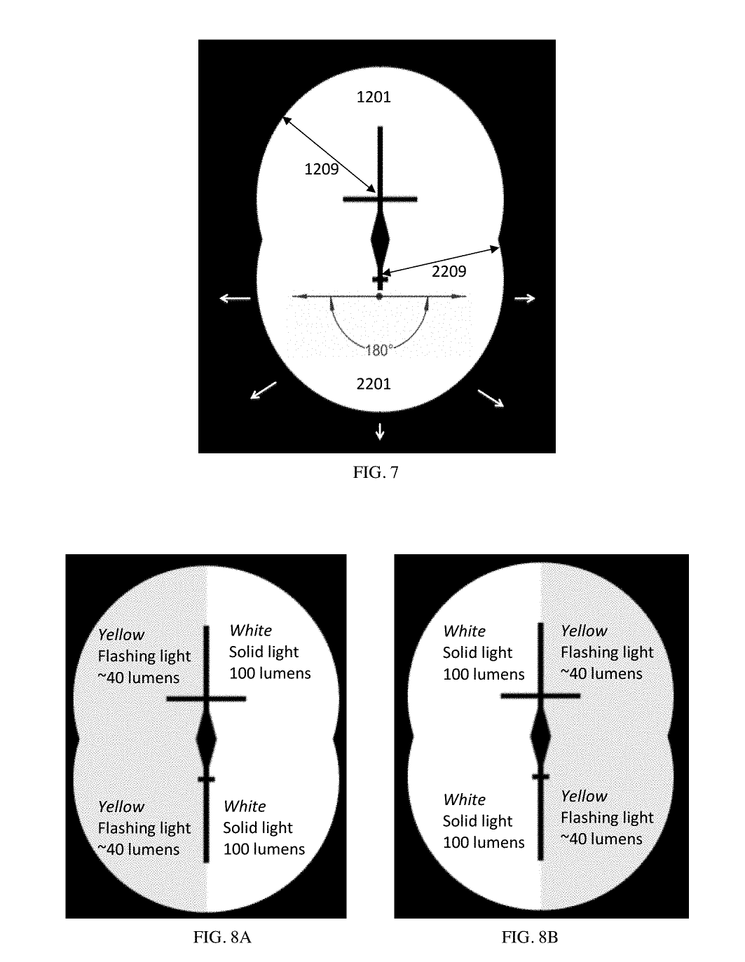

Further from FIGS. 5 and 6, the directional light 110 of front light 100 emits light and projects a coned light field 1101 on the anterior area of the handle bar of the bicycle; the rear visibility light 210 of front light 200 emits light and projects a coned light field 2101 on the posterior area of the saddle of the bicycle. Optionally, two more rear visibility light 210 can be adopted to project light fields 2101 on the left side and right side of the saddle of the bicycle to increase the visibility of nearby objects and road conditions. When adjusting the size lens 2202 of the three rear visibility lights 210 facing left, right and rear side, the angle of light field can be increased up to 180° visibility, which also increase the area of safety space, as shown in FIG. 7.

In one aspect, ground lights 120 and 220 emit stronger lights and reach a luminous flux of 50-200 lumens that is conspicuous to other road users. Under such high luminous flux, the shadow of the cyclist becomes unnoticeable and hence creating a full pattern of safety space. In contrast, directional light 110 and rear visibility light 210 emit lights with lower luminous flux which prevents blinding other commuters nearby.

In one embodiment, each of ground lights 120 and 220 has at least two LEDs and corresponding lens such that one of the emitted light is semi-circle in shape projected on to one side adjacent to the bicycle when the light passes through the shaping lens 1206 or 2206, the other emitted light projected on to the opposite side adjacent to the bicycle, as depicted on FIGS. 8A and 8B. In one embodiment, different colored LEDs are used to project two different colored light-fields on left side and right side of the bicycle to represent turn signals. Each of switch sets 170, 270, and 310 includes two buttons for activating the turn signals—one for left turn and another for right turn. In one exemplary embodiment as shown in FIG. 8A, where safety space is activated—ground lights 120 and 220 were turned on and white light of 100 lumens of illuminance flux is emitted, when the cyclist prepares to turn left and turns on an activation button of switch sets, the control modules 160 and 260 generate and send the corresponding control signal to switch the LEDs on the left side to a weaker flashing mode and emits yellow light. The contrast in lighting mode and light color enhances visibility of the bicycle thus effectively alerts approaching motorists or riders from their perspectives. The turn signal lights of front light 100 and rear light 200 can work independently corresponding to their respective control modules; or the control modules 160 and 260 may work collaboratively under the master control module 360 of the remote controller 300 such that only buttons of the switch set 310 of the remote controller 300 requires cyclist's attention.

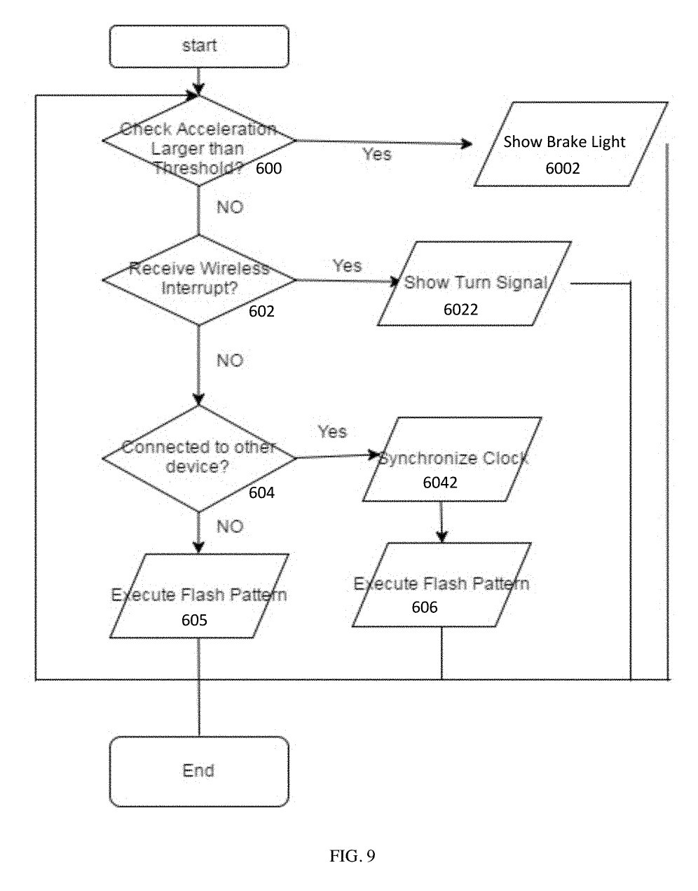

FIG. 9 illustrates the schematic flow of the data and commands of the turn signaling operation comprising the control module 160, 260, or 360 comparing the accelerometer reading with the threshold value 600; if accelerometer 140, 240, or 340 reading is higher than the threshold value 600, then the control module 160, 260, or 360 causes to turn on the brake light (6002), otherwise proceeds to detect and receive wireless interrupts from the wireless module 130, 230, and/or 330 (602); if a wireless interrupt occurs, then the control module 160, 260, or 360 causes to activate the turn signal (6022), otherwise proceeds to verify connections with other components and modules, and/or other external devices (604); if connections are established, the internal clock of the 160, 260, or 360 is synchronized with the components and modules, and/or other external devices (6042); followed by the control module 160, 260, or 360 sending the control signals to the LEDs of the ground lights 120 and/or 220 to generate synchronized flash patterns by multiple light sources (605); otherwise, the flash patterns are generated without the internal clock synchronization (606).

Optionally, more settings can be customized by a mobile device application 400, for example a mobile phone app, to directly control other components such as front light 100 or rear light 200 via remote controller 300, or directly control over the other components. A smart bicycle helmet 500 having signal lighting functions can also be adopted in the system of the present invention to provide synchronized turning signals.

The embodiments disclosed herein may be implemented using general purpose or specialized computing devices, computer processors, or electronic circuitries including but not limited to application specific integrated circuits (ASIC), field programmable gate arrays (FPGA), and other programmable logic devices configured or programmed according to the teachings of the present disclosure.

Portions or all of the mobile device application in the various embodiments may be executed in one or more general purpose or computing devices including server computers, personal computers, laptop computers, mobile computing devices such as “smartphones” and “tablet” computers

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system of light projected visual safety space for a transportation device comprising:
a front light and a rear light coupled to the transportation device;
wherein both the front light and rear light comprise a ground light,
wherein the ground light inclines beyond a pre-defined angle from the perpendicular to the ground and emits light in a cone shape of light field on pre-determined positions beneath top portions of the transportation device proximal to the bicycle defining the visual safety space.

2. The system of light projected visual safety space for a transportation device according to claim 1, wherein the ground light of either or both the front light and the rear light comprises a size lens to adjust the size of the emitted light, a shaping lens for modifying the shape of the emitted light and a LED as the light source.

3. The system of light projected visual safety space for a transportation device according to claim 1, wherein at least one of the front light and rear light comprises a control module controlling and modifying at least one of the aspects of size, shape, color, intensity and frequency of emitted light and light emission modes, wherein the light emission modes comprise solid/constant and strobe/flash light modes.

4. The system of light projected visual safety space for a transportation device according to claim 3, wherein at least one of the front light and rear light comprises a switch set for activation or alteration at least one of aspects controlled and modified by the control module.

5. The system of light projected visual safety space for a transportation device according to claim 4, wherein the system further comprises a remote controller for controlling over the control modules of the front light or the rear light.

6. The system of light projected visual safety space for a transportation device according to claim 5, wherein the system further comprises a mobile device application for control over settings and functions of the front light, the rear light and the remote controller.

7. The system of light projected visual safety space for a transportation device according to claim 1, wherein both the front light and rear light comprises a wireless module for communications within the front light and the rear light to synchronize settings or lighting mode of the emitted light.

8. The system of light projected visual safety space for a transportation device according to claim 1, wherein at least one of the front light and the rear light comprises an accelerometer for measuring acceleration of the transportation device for activating a brake light when the acceleration of the transportation device is higher than a threshold.

9. The system of light projected visual safety space for a transportation device according to claim 1, further comprising a radar module to monitor surrounding objects and their travelling speed;
wherein the rear light comprises a control module controlling and modifying at least one of the aspects of size, shape, color, intensity and frequency of emitted light and light emission modes in accordance to the speed of the surrounding objects.

10. The system of light projected visual safety space for a transportation device according to claim 1, wherein a light sensor is coupled to the front light or rear light monitoring the lighting intensity proximal to cyclists and one or more of the front light and rear light adjust the luminance of light in response to environment change.

11. The system of light projected visual safety space for a transportation device according to claim 1, wherein the transportation device is a bicycle.

12. The system of light projected visual safety space for a transportation device according to claim 1, wherein the transportation device is a tricycle.

13. The system of light projected visual safety space for a transportation device according to claim 1, wherein the transportation device is a motorcycle.

14. The system of light projected visual safety space for a transportation device according to claim 1, wherein the transportation device is a moped.
